(19) United States
(12) Patent Application Publication
(10) Pub. No.: US 2026/0334592 A1
(43) Pub. Date: Oct. 29, 2026

(54) ELECTRICAL CONNECTION STRUCTURE AND AEROSOL GENERATING DEVICE

(71) Applicant: SHENZHEN GEEKVAPE TECHNOLOGY CO., LTD., SHENZHEN (CN)

(72) Inventors: HUAPING LIAO, SHENZHEN (CN); JINGHAN LI, SHENZHEN (CN)

(21) Appl. No.: 19/446,947

(22) Filed: Jan. 13, 2026

(30) Foreign Application Priority Data
Apr. 27, 2025 (CN) 202520809911.2
Apr. 27, 2025 (CN) 202520815363.4

(51) Int. Cl. A24F 40/95; H01R 12/71; H01R 13/24; H01R 13/645; H01R 13/66; H01R 13/62

(52) U.S. Cl. CPC A24F 40/95; H01R 12/716; H01R 13/2471; H01R 13/645; H01R 13/6658; H01R 13/6205

(57) ABSTRACT

An electrical connection structure for an aerosol generating device, comprising: a first circuit board, a first connector, a second circuit board, a second connector and a conductive member, the first circuit board is mechanically and electrically connected to the first connector, the second circuit board is mechanically and electrically connected to the second connector, the second connector abuts against and is electrically connected to the conductive member, the first connector comprises a connecting portion and an elastic portion, the elastic portion is connected to the connecting portion, the elastic portion abuts one of the conductive member and the second circuit board, the connecting portion is electrically connected to another one of the conductive member and the second circuit board.

### CROSS REFERENCE TO RELATED APPLICATIONS

This application claims priority to Chinese Patent Application No. 202520815363.4, filed on Apr. 27, 2025 and Chinese Patent Application No. 202520809911.2, filed on Apr. 27, 2025. The entire disclosure of each of the foregoing applications is hereby incorporated by reference herein.

### TECHNICAL FIELD

The present application relates to the field of aerosol-generation technology, and more particularly to an electrical connection structure and an aerosol generating device.

### BACKGROUND

To enable an aerosol generating device to have more functions and meet user needs, some aerosol generating devices are provided with two circuit boards, namely a main circuit board and a sub circuit board, which are electrically connected via an electrical connection structure. For example, in an aerosol generating device that the atomization module and the power supply module are detachable, an electrical connection structure is required to electrically connect the main circuit board in the atomization module and the sub circuit board in the power supply module.

In the related art, an electrical connection structure generally includes copper pillars disposed on a main circuit board and spring-loaded pins disposed on a sub circuit board. Since the spring-loaded pins need to be abut against the copper pillars to achieve electrical connection therebetween, the main circuit board and the sub circuit board must be assembled in parallel. This not only causes the main circuit board and the sub circuit board to occupy a relatively large space in the aerosol generating device, but also makes assembly difficult.

### SUMMARY

The primary objective of the present application is to provide an electrical connection structure and an aerosol generating device to solve the problem in the related art that the main circuit board and the sub circuit board occupy a relatively large space in the aerosol generating device and are difficult to assemble.

In a first aspect, the present disclosure provides an electrical connection structure for an aerosol generating device, comprising: a first circuit board being mechanically and electrically connected to a first connector; a second circuit board being mechanically and electrically connected to a second connector; and a conductive member, wherein the second connector abuts against and is electrically connected to the conductive member; wherein the first connector comprises a connecting portion and an elastic portion, the elastic portion is connected to the connecting portion, the elastic portion abuts one of the conductive member and the first circuit board, the connecting portion is electrically connected to another one of the conductive member and the first circuit board.

In some embodiments, the elastic portion and the second connector respectively abut two opposite ends of the conductive member.

In some embodiments, the electrical connection structure further comprises a bracket, wherein a receiving hole is defined in the bracket, the conductive member is disposed in the receiving hole, the bracket forms a limiting surface in the receiving hole, and the elastic portion presses against the conductive member such that the conductive member abuts against the limiting surface.

In some embodiments, the receiving hole comprises a first hole and a second hole in communicating with the first hole, the limiting surface is formed at a junction between the first hole and the second hole; the conductive member comprises a first portion and a second portion connected to the first portion, the first portion is located in the first hole, the second portion is located in the second hole, the elastic portion abuts against an end of the first portion away from the second portion, the second connector abuts against an end of the second portion away from the first portion.

In some embodiments, the first circuit board and the second circuit board are arranged perpendicularly, the second connector and the second circuit board are arranged perpendicularly.

In some embodiments, the first circuit board is arranged horizontally, the connecting portion is disposed on an outer surface of the first circuit board, and the connecting portion is mechanically and electrically connected to the first circuit board.

In some embodiments, the second connecting member is a spring-loaded pin, a central axis of the second connector is parallel to the first circuit board, the elastic portion extends from the connecting portion toward the central axis of the second connector, and a part of the elastic portion is bent toward the conductive member to form an arc connecting section, and the arc connecting section presses against the conductive member.

In some embodiments, the electrical connection structure comprises a first connection assembly and a second connection assembly, the first connection assembly comprises a plurality of the first connectors, the second connection assembly comprises a plurality of the second connectors, one of the first connection assemblies and the second connection assemblies further comprises a plurality of the conductive members, the first connectors, the second connectors, and the conductive members are consistent in quantity, and the first connectors, the second connectors, and the conductive members are arranged in a one-to-one correspondence manner.

In some embodiments, the conductive member and the first connector are of an integral sheet structure, the connecting portion is connected between the elastic portion and the conductive member, the elastic portion abuts against the first circuit board.

In some embodiments, the electrical connection structure further comprises a bracket, the conductive member is disposed on an outer surface of the bracket, and the conductive member is located between the second connecting member and the bracket.

In some embodiments, the electrical connection structure further comprises a mounting member, wherein the first circuit board is arranged horizontally and disposed on the mounting member, the second circuit board is arranged perpendicularly, the second connecting member is a spring-loaded pin, and the second connecting member is arranged horizontally.

In some embodiments, the second touch sensing portion generates the second capacitance signal when any touch point on the third touch surface or any touch point on the fourth touch surface is touched.

In some embodiments, the connecting portion is embedded in the bracket, and the first circuit board presses against the elastic portion to cause the elastic portion to be elastically deformed and be electrically connected to the first circuit board.

In some embodiments, the connecting portion is perpendicular to the conductive member, and the conductive member is integrally formed and embedded in the bracket.

In some embodiments, the elastic portion and the conductive member are respectively located on a same side of the connecting portion; the elastic portion comprises a first state and a second state; in the first state, the elastic portion is not in contact with the first circuit board and is suspended above the bracket; in the second state, the first circuit board presses against the elastic portion, and the elastic portion is elastically deformed and abuts against the bracket.

In some embodiments, the elastic portion comprises a first arm, a second arm, and a third arm, the first arm is connected to the connecting portion and extends obliquely in a direction toward the first circuit board and away from the connecting portion, the second arm extends obliquely from an end of the first arm away from the connecting portion in a direction away from the first circuit board and away from the connecting portion, and the third arm extends horizontally from an end of the second arm away from the first arm in a direction away from the connecting portion.

In some embodiments, the mounting member comprises a plurality of support ribs and a plurality of limiting portions, the plurality of support ribs respectively support a first surface that is of the first circuit board and is adjacent to the elastic portion, and the plurality of limiting portions respectively limit a second surface that is of the first circuit board and is away from the elastic portion.

In a second aspect, the present disclosure further provides an aerosol generating device, the aerosol generating device comprises the electrical connection structure.

In some embodiments, the aerosol generating device further comprises an atomization module and a power supply module. The atomization module comprises a first housing, the first circuit board, the first connector and the conductive member; the first housing defines a first receiving room, the first circuit board and the first connector are respectively disposed in the first receiving room. The conductive member is disposed on the first housing or in the first housing, the conductive member is partially exposed outside of the first housing, and the conductive member is electrically connected to the first connector. The power supply module comprises a second housing, the second circuit board, and the second connector. The second housing defines a second receiving room, the second circuit board and the second connector are disposed in the second housing, the second connector is partially exposed outside of the second housing. When the atomization module is connected to the power supply module, the second connector abuts against and is electrically connected to the conductive member.

In a third aspect, the present disclosure further provides an aerosol generating device. The aerosol generating device comprises a first housing, a first circuit board, a first connector and a conductive member. The first housing defines a first receiving room, the first circuit board and the first connector are respectively disposed in the first receiving room, and the first circuit board is horizontally arranged. The first connector comprises a connecting portion and an elastic portion, and the connecting portion is disposed on the first circuit board and is electrically connected to the first circuit board. The elastic portion is connected to the connecting portion, the conductive member is disposed on the first housing or in the first housing, the conductive member is partially exposed outside of the first housing, and the conductive member abuts against the elastic portion. The aerosol generating device further comprises a second housing, a second circuit board, and a second connector. The second housing defines a second receiving room, the second circuit board and the second connector are disposed in the second receiving room. The second circuit board is perpendicularly arranged, the second connecting member is a spring-loaded pin and horizontally arranged. The second connector is electrically connected to the second circuit board, and the second connector is partially exposed outside of the second housing. When the first housing is connected to the second housing, the elastic portion and the second connector respectively abut two opposite ends of the conductive member.

In a fourth aspect, the present disclosure further provides an aerosol generating device comprising: a first housing, a first circuit board, a first connector and a conductive member. The first housing defines a first receiving room, and the first circuit board and the first connector are respectively disposed in the first receiving room. The first circuit board is horizontally arranged. The conductive member and the first connector are of an integral sheet structure. The first connector comprises a connecting portion and an elastic portion. The connecting portion is connected between the conductive member and the elastic portion, the conductive member is disposed on the first housing or in the first housing, the conductive member is partially exposed outside of the first housing, and the elastic portion abuts against the first circuit board and is electrically connected to the first circuit board. The aerosol generating device further comprises a second housing, a second circuit board, and a second connector. The second housing defines a second receiving room, and the second circuit board and the second connector are disposed in the second receiving room. The second circuit board is perpendicularly arranged, the second connector is spring-loaded pin and horizontally arranged. The second connector is electrically connected to the second circuit board, and the second connector is partially exposed outside of the second housing. When the first housing is connected to the second housing, the second connector abuts against and is electrically connected to the conductive member, the second circuit board is electrically connected to the first circuit board, and the first circuit board is perpendicular to the second circuit board.

The electrical connection structure provided by the embodiment of the application have the beneficial effects that since the first circuit board is mechanically and electrically connected to the first connector, and the first connector includes a connecting portion and an elastic portion, the elastic portion is connected to the connecting portion; the second circuit board is mechanically and electrically connected to the second connector; and the electrical connection structure further includes the conductive member, the second connector abuts against the conductive member; when electrical connection between the first circuit board and the second circuit board is required, it is only necessary for the elastic portion to abuts against one of the conductive member and the second circuit board, and for the connecting portion to be electrically connected to the other of the conductive member and the second circuit board. This enables the first connector and the second connector to be electrically connected via the conductive member, with the first connector and the second connector not directly connected. Thus, the first circuit board and the second circuit board can be arranged more flexibly, occupy less space in the aerosol generating device, and facilitate assembly. For the beneficial effects of the aerosol generating device provided by the present application compared with the prior art, reference may be made to the description of the beneficial effects of the electrical connection structure provided by the present application compared with the prior art, and details are not repeated herein.

### BRIEF DESCRIPTION OF THE DRAWINGS

The accompanying drawings described here are used to provide to further understanding of the present application and constitute a part of the same. The illustrative embodiments of the present application and their descriptions are used to explain the present application and do not constitute an improper limitation of the present application. In the drawings:

FIG. 1 is a schematic structural view of an aerosol generating device according to an embodiment of the present application.

FIG. 2 is a top view of the aerosol generating device in FIG. 1.

FIG. 3 is cross-section view along M-M of the aerosol generating device in FIG. 2.

FIG. 4 is a partially enlarged view of a position A in FIG. 3.

FIG. 5 is a schematic structural view of the first connector and the first circuit board in the aerosol generating device shown in FIG. 3.

FIG. 6 is a front view of the first connector and the first circuit board shown in FIG. 5.

FIG. 7 is a schematic structural view of the first connector shown in FIG. 5.

FIG. 8 is an overall schematic view of an aerosol generating device in one embodiment of the present application.

FIG. 9 is a cross-section view along A-A1 in FIG. 8, showing the adjustment member in a first position.

FIG. 10 is an enlarged schematic view of portion A in FIG. 9.

FIG. 11 is an overall schematic view of an atomization module in one embodiment of the present application.

FIG. 12 is an overall schematic view of a power supply module in one embodiment of the present application.

FIG. 13 is a schematic view of engagement between a bracket and an conductive spring sheet in one embodiment of the present application.

FIG. 14 is a schematic view of engagement between the bracket and the conductive spring sheet in one embodiment of the present application from another perspective.

FIG. 15 is a cross-section schematic view along B-B1 in FIG. 14.

FIG. 16 is a schematic view of a conductive spring sheet in one embodiment of the present application.

FIG. 17 is a schematic exploded view of an aerosol generating device in one embodiment of the present application.

FIG. 18 is a cross-section view along A-A1 in FIG. 8, showing the adjustment member in a second position.

FIG. 19 is a cross-section view along A-A1 in FIG. 8, showing the adjustment member in a third position.

Aerosol generating device 100,
Atomization module 10,
Atomization unit 11,
Atomization tube 111,
Liquid guide hole 1111,
Liquid guide cotton 112,
Heating element 113,
First circuit board 12,
Limiting hole 121,
First connection assembly 13,
First connector 131,
Conductive member 1311,
First part 13111,
Second part 13112,
First arm 1314,
Second arm 1315,
Third arm 1316,
Elastic portion 1317,
Connecting portion 1318,
Arc connecting section 1319,
First housing 14,
First receiving room 141,
Bracket 15,
First avoidance hole 151,
Receiving hole 152,
First hole 1521,
Second hole 1522,
limiting surface 1523,
Mounting member 16,
Support rib 161,
First power battery 17,
First charging interface 18,
Mouthpiece 19,
Power supply module 20,
Second circuit board 21,
Second connection assembly 22,
Second connector 221,
Second power battery 23,
Second housing 24,
Second receiving room 242,
Second avoidance hole 241,
Second charging interface 25,
Control button 26,
Control switch 27,
Connection module 30,
First magnetic member 31,
Second magnetic member 32,
Mouthpiece section 411,
Atomization section 412,
Air inlet section 413,
Mounting seat 42,
Liquid passage hole 421,
Liquid storage chamber 43,
Buffer chamber 44,
Adjustment member 45,
Air inlet hole 451,
Blocking member 461,
Pushing member 462,
Sealing member 47,
Airflow path L.

### DETAILED DESCRIPTION

It should be noted that, where there is no conflict, the embodiments of the present application and the features in the embodiments may be combined with each. The present application will be described in detail below with reference to the accompanying drawings and in conjunction with the embodiments.

It should also be noted that the terms used herein are only for the purpose of describing particular embodiments and is not intended to limit the exemplary embodiments according to the present application. As used herein, unless the context clearly indicates otherwise, the singular forms also include the plural forms. Furthermore, it should be understood that when the terms “comprise” and/or “include” are used in this specification, they indicate the presence of stated features, steps, operations, devices, components, and/or combinations thereof.

Unless specifically stated otherwise, the relative arrangements of components and steps, numerical expressions, and numerical values set forth in these embodiments do not limit the scope of the present application. Meanwhile, it should be understood that, for ease of description, the dimensions of various parts shown in the drawings are not drawn in accordance with actual proportional relationships. Technologies, methods, and devices known to ordinary skilled persons in the relevant art may not be discussed in detail, but where appropriate, the technologies, methods, and devices should be regarded as part of the authorized specification. In all examples shown and discussed herein, any specific value should be construed as merely exemplary, and not as a limitation. Therefore, other examples of the exemplary embodiments may have different values. It should be noted that similar reference numerals and letters denote similar items in the following drawings; therefore, once an item is defined in one drawing, no further discussion thereof is required in subsequent drawings.

To enable an aerosol generating device 100 to have more functions and meet user needs, some aerosol generating devices 100 are provided with two circuit boards, namely a main circuit board and a sub circuit board, which are electrically connected via an electrical connection structure. For example, in an aerosol generating device 100 where the atomization module 10 and the power supply module 20 are detachable, an electrical connection structure is required to electrically connect the main circuit board in the atomization module 10 and the sub circuit board in the power supply module 20.

In the related art, an electrical connection structure generally includes copper pillars disposed on a main circuit board and spring-loaded pins disposed on a sub circuit board. Since the spring-loaded pins need to be abuts against the copper pillars to achieve electrical connection therebetween, the main circuit board and the sub circuit board must be assembled in parallel with each other. This not only causes the main circuit board and the sub circuit board to occupy a relatively large space in the aerosol generating device 100, resulting in a relatively large overall size of the aerosol generating device 100 that is inconvenient for users to hold and carry, but also has the problem of difficult assembly.

### Embodiment 1

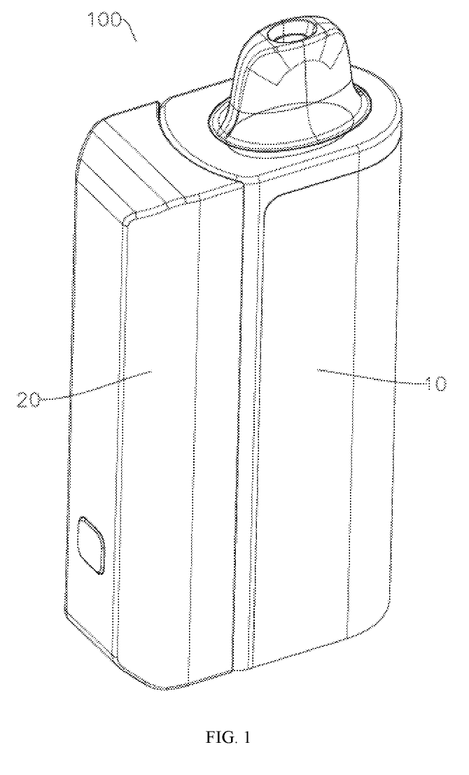

Referring to FIGS. 1-7, the present application provides an electrical connection structure and an aerosol generating device 100. The electrical connection structure comprises a first circuit board 12, a first connector 131, a second circuit board 21, a second connector 221, and a conductive member 1311.

Since the first circuit board 12 is mechanically and electrically connected to the first connector 131, and the first connector 131 includes a connecting portion 1318 and an elastic portion 1317 and the elastic portion 1317 is connected to the connecting portion 1318; the second circuit board 21 is mechanically and electrically connected to the second connector 221. The second connector 221 abuts against the conductive member 1311. When an electrical connection between the first circuit board 12 and the second circuit board 21 is required, it is only necessary for the elastic portion 1317 to abuts against one of the conductive members 1311 and the second circuit board 21, and for the connecting portion 1318 to be electrically connected to the other of the conductive member 1311 and the first circuit board 12. This enables the first connector 131 and the second connector 221 to be electrically connected via the conductive member 1311, with the first connector 131 and the second connector 221 not directly connected. Thus, the first circuit board 12 and the second circuit board 21 can be arranged more flexibly in the aerosol generating device 100, occupy less space in the aerosol generating device 100 respectively, and facilitate assembly.

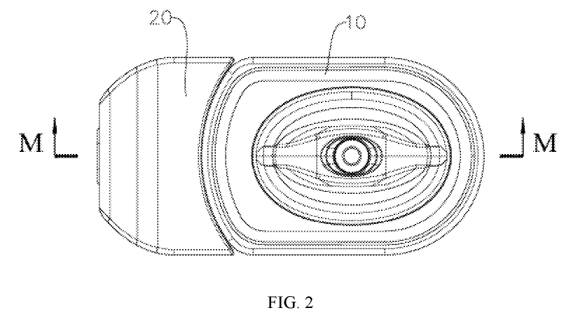

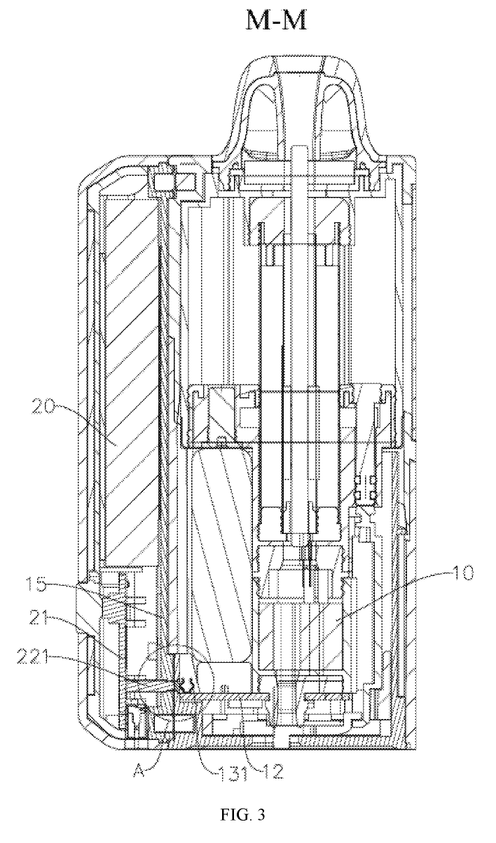

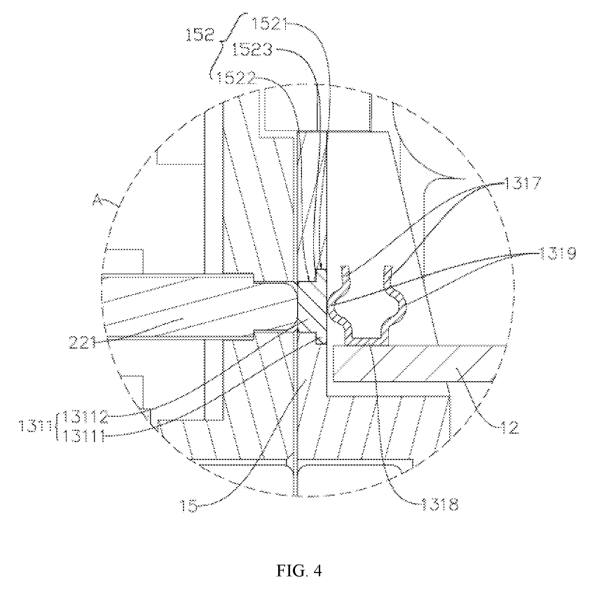

Please referring to FIGS. 1-4, FIG. 1 is a schematic structural view of an aerosol generating device according to an embodiment of the present application, FIG. 2 is a top view of the aerosol generating device in FIG. 1, FIG. 3 is cross-section view along M-M of the aerosol generating device in FIG. 2, FIG. 4 is a partially enlarged view of a position A in FIG. 3.

The embodiments of the present application provide an electrical connection structure for the aerosol generating device 100, and the electrical connection structure comprises the first circuit board 12, the second circuit board 21, and the conductive member 1311.

The first circuit board 12 is electrically and mechanically connected to the first connector 131.

The second circuit board 21 is electrically and mechanically connected to the second connector 221.

One of the first circuit board 12 and the second circuit board 21 may be a main circuit board, and another one of the first circuit board 12 and the second circuit board 21 may be a sub circuit board. In the present embodiment, the first circuit board 12 is the main circuit board, and the second circuit board 21 is the sub circuit board. In other embodiments, the first circuit board 12 may be configured as the sub circuit board, and the second circuit board 21 may be configured as the main circuit board.

Both the first connector 131 and the second connector 221 are conductive; for example, the first connector 131 and the second connector 221 may be configured as spring-loaded pin, conductive spring sheet, etc. The first circuit board 12 and the first connector 131 may be connected to each other by welding, adhesion, clamping, bolt connection, screw connection, etc., and are electrically connected therebetween. The second circuit board 21 and the second connector 221 may be connected to each other by the same connection methods as described above, and are electrically connected therebetween.

The conductive member 1311 may be connected to other components of the aerosol generating device 100, and the conductive member 1311 is conductive. The conductive member 1311 may be made from electrically conductive metallic materials, such as copper, silver, iron, aluminum, or other metallic conductive materials. Alternatively, the conductive member 1311 may be made from electrically conductive non-metallic materials, such as graphite, conductive ceramics, or other non-metallic conductive materials. The shape of the conductive member 1311 may be a cylinder, cuboid, cube, frustum of a cone, etc., and which are not specifically limited herein.

The first connector 131 abuts against and is electrically connected to the conductive member 1311, and the second connector 221 abuts against and is electrically connected the conductive member 1311, such that the first connector 131 and the second connector 221 are electrically connected via the conductive member 1311.

Since the first connector 131 and the second connector 221 are not directly electrically connected, but rather indirectly electrically connected via the conductive member 1311, the first circuit board 12 and the second circuit board 21 are electrically connected. Thus the first connector 131 and the second connector 221can be arranged more flexibly in the aerosol generating device 100. For example, the first circuit board 12 and the second circuit board 21 may be arranged perpendicular to each other in the aerosol generating device 100, or the first circuit board 12 and the second circuit board 21 may be arranged at other angles in the aerosol generating device 100. This avoids the limitation that the first circuit board 12 and the second circuit board 21 can only be arranged parallel to each other in the aerosol generating device 100, thereby preventing the first circuit board 12 and the second circuit board 21 from occupying a relatively large installation space in the aerosol generating device 100 and facilitating assembly.

From the above, in the electrical connection structure provided by the embodiments of the present application, since the first circuit board 12 is mechanically and electrically connected to the first connector 131, the second circuit board 21 is mechanically and electrically connected to the second connector 221, and the electrical connection structure further includes the conductive member 1311, electrical connection between the first circuit board 12 and the second circuit board 21 can be achieved merely by abutting the first connector 131 against the conductive member 1311 and abutting the second connector 221 against the conductive member 1311. This enables the first connector 131 and the second connector 221 to be electrically connected via the conductive member 1311 without direct connection therebetween. Thus, the first circuit board 12 and the second circuit board 21 can be arranged more flexibly, occupy less installation space in the aerosol generating device 100 respectively, and facilitate assembly.

The first connector 131 need not be disposed at the edge of the first circuit board 12, and the second connector 221 need not be disposed at the edge of the second circuit board 21.

Through such arrangement, when the first circuit board 12 and the second circuit board 21 are respectively disposed in the aerosol generating device 100, this avoids collision between the first connector 131 and other components of the aerosol generating device 100, and between the second connector 221 and said other components respectively.

In the embodiments of the present application, the first connector 131 and the second connector 221 respectively abut two opposite ends of the conductive member 1311. In other words, the elastic portion 1317 and the second connector 221 respectively abut two opposite ends of the conductive member 1311, or the connecting portion 1318 and the second connector 221 respectively abut two opposite ends of the conductive member 1311.

Through such arrangement, the directions of the forces exerted by the first connector 131 on the conductive member 1311 and by the second connector 221 on the conductive member 1311 are opposite to each other. This ensures the positional stability of the conductive member 1311 during use of the aerosol generating device 100, preventing the conductive member 1311 from moving, thereby ensuring the stability of the electrical connection between the first circuit board 12 and the second circuit board 21, and further ensuring the stability of the aerosol generating device 100 during use.

In the embodiment of the present application, please referring to FIG. 4, the first connector 131 and the second connector 221 respectively abut the left end and the right end of the conductive member 1311. The direction of the force exerted by the first connector 131 on the conductive member 1311 is from left to right, and the direction of the force exerted by the second connector 221 on the conductive member 1311 is from right to left. Therefore, the first connector 131 and the second connector 221 respectively abutting the opposite left and right ends of the conductive member 1311 can prevent the conductive member 1311 from moving to the left or right.

Please referring to FIGS. 1-4, in the embodiment of the present application, the electrical connection structure further includes a bracket 15. The bracket 15 is at least partially located between the first connector 131 and the second connector 221, and the conductive member 1311 is disposed in the bracket 15 and respectively connected to the first connector 131 and the second connector 221.

Through such arrangement, the bracket 15 can define the position of the conductive member 1311, preventing the conductive member 1311 from moving arbitrarily, which would improve the stability of the electrical connection between the first connector 131 and the second connector 221. Additionally, the bracket 15 can separate the first connector 131 from the second connector 221.

It can be understood that the bracket 15 may be insulating to prevent the conductive member 1311 from being electrically connected to other components of the aerosol generating device 100 via the bracket 15.

The bracket 15 and the conductive member 1311 may be connected to each other by welding, adhesion, clamping, bolt connection, screw connection, etc.

As an implementable embodiment, the bracket 15 defines a receiving hole 152, and at least part of the conductive member 1311 is located in the receiving hole 152.

Through such arrangement, the receiving hole 152 can define the mounting position of the conductive member 1311, thereby facilitating the connection between the bracket 15 and the conductive member 1311 and ensuring the connection accuracy therebetween.

It can be understood that the entire conductive member 1311 may be disposed in the receiving hole 152, or only part of the conductive member 1311 may be disposed in the receiving hole 152.

In the embodiment of the present application, the bracket 15 forms a limiting surface 1523 in the receiving hole 152. The elastic portion 1317 presses against the conductive member 1311, causing the conductive member 1311 to abut against the limiting surface 1523. Thus, under the limiting action of the elastic portion 1317 and the limiting surface 1523, the conductive member 1311 can be stably limited in the receiving hole 152, thereby enabling the first connector 131 and the second connector 221 to stably abut against the conductive member 1311 respectively.

In the embodiment of the present application, please referring to FIG. 4, the receiving hole 152 includes a first hole 1521 and a second hole 1522 in communication with each other. The aperture of the first hole 1521 is larger than that of the second hole 1522, such that the limiting surface 1523 is formed at the junction of the first hole 1521 and the second hole 1522. The conductive member 1311 includes a first part 13111 and a second part 13112 that are connected to each other. An end of the first part 13111 remote from the second part 13112 abuts against the first connector 131, and an end of the second part 13112 remote from the first part 13111 abuts against the second connector 221. The first part 13111 is located in the first hole 1521, and the second part 13112 is located in the second hole 1522.

Through such arrangement, after the conductive member 1311 is disposed in the receiving hole 152, a bottom wall surface of the first hole 1521 facing away from the second hole 1522 can abut against the first part 13111, limiting the movement of the first part 13111 toward the second connector 221. Thus, the positions of the first part 13111 and the second part 13112 can be defined along the axial direction of the first hole 1521.

In addition, under the elastic abutment of the first connector 131 on the end of the first part 13111 remote from the second part 13112, and under the limiting action of the bottom wall surface of the first hole 1521 on the end of the first part 13111 close to the second part 13112, the conductive member 1311 can be stably connected to the bracket 15.

It can be understood that the first hole 1521 and the second hole 1522 may be coaxially arranged to facilitate the processing of the receiving hole 152.

In the embodiment of the present application, the bracket 15 and the conductive member 1311 are injection-molded as an integral part.

Through such arrangement, the bracket 15 and the conductive member 1311 can be connected tightly. Additionally, it avoids the need to separately pre-process the receiving hole 152 and then assemble the conductive member 1311 into the receiving hole 152, thereby simplifying the assembly steps of the conductive member 1311 and the bracket 15 and improving the stability of the connection between the conductive member 1311 and the bracket 15.

In the embodiment of the present application, the first circuit board 12 and the second circuit board 21 are arranged perpendicular to each other.

Through such arrangement, the positions of the first circuit board 12 and the second circuit board 21 in the aerosol generating device 100 can be arranged more conveniently, and the installation space occupied by the first circuit board 12 and the second circuit board 21 in the aerosol generating device 100 is reduced.

It should be noted that the first circuit board 12 and the second circuit board 21 being arranged perpendicular to each other may include: the length direction of the first circuit board 12 is perpendicular to the length direction of the second circuit board 21, and the length direction of the first circuit board 12 is perpendicular to the width direction of the second circuit board 21; or the width direction of the first circuit board 12 is perpendicular to the length direction of the second circuit board 21, and the width direction of the first circuit board 12 is perpendicular to the width direction of the second circuit board 21.

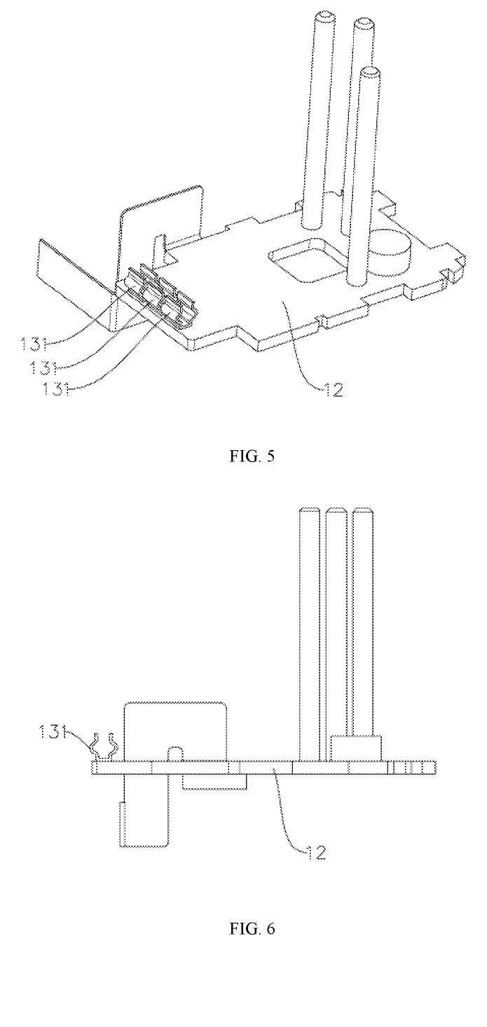

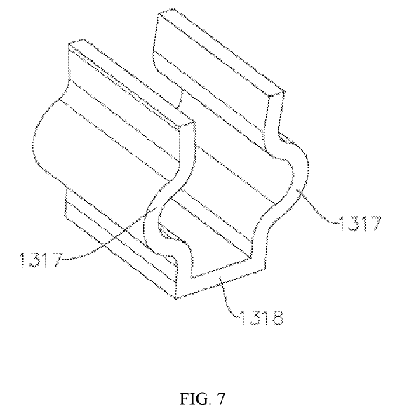

Please referring to FIGS. 1-7, FIG. 5 is a schematic structural view of the first connector 131 and the first circuit board 12 in the aerosol generating device 100 shown in FIG. 3. FIG. 6 is a front view of the first connector 131 and the first circuit board 12 shown in FIG. 5. FIG. 7 is a schematic structural view of the first connector 131 shown in FIG. 5.

In the present embodiment, the first connector 131 includes an elastic portion 1317 and a connecting portion 1318 that are connected to each other. The elastic portion 1317 abuts the conductive member 1311, the connecting portion 1318 is connected to the outer surface of the first circuit board 12, and the connecting portion 1318 is electrically connected to the first circuit board 12.

Through such arrangement, the first connector 131 can be conveniently connected to the first circuit board 12. Since the connecting portion 1318 is connected to the outer surface of the first circuit board 12 and is electrically connected thereto, the first circuit board 12 and the connecting portion 1318 can be connected tightly. This ensures a high connection strength between the first connector 131 and the first circuit board 12, thereby enabling stable electrical connection between the first connector 131 and the first circuit board 12.

It should be noted that a pad may be provided on the first circuit board 12, the pad defines a part of the outer surface of the first circuit board 12, and the connecting portion 1318 is connected to the pad and electrically connected thereto. The connecting portion 1318 and the pad may be soldered together and electrically connected via reflow soldering.

In the embodiment of the present application, the first circuit board 12 is arranged horizontally, and the connecting portion 1318 is disposed on the outer surface of the first circuit board 12. The connecting portion 1318 is electrically and connected with the first circuit board 12, such that the connecting portion 1318 can be stably connected to the first circuit board 12, and the elastic portion 1317 can elastically abuts the conductive member 1311.

In the embodiment of the present application, the contact between the elastic portion 1317 and the conductive member 1311 may be surface contact or line contact, which is not specifically limited herein, as long as the elastic portion 1317 can stably contact and be electrically connected with the conductive member 1311.

It can be understood that a bump may be provided on the elastic portion 1317, and the bump abuts the conductive member 1311, such that the elastic portion 1317 can stably contact and be electrically connected with the conductive member 1311.

In the embodiment of the present application, two elastic portions 1317 are provided, and the two elastic portions 1317 are respectively located at two opposite ends of the connecting portion 1318 and symmetrically arranged at the opposite ends of the connecting portion 1318. One of the elastic portions 1317 abuts the conductive member 1311.

Through such arrangement, the first connector 131 can be directly placed on the outer surface of the first circuit board 12. Since the connecting portion 1318 is disposed on the outer surface of the first circuit board 12, the first connector 131 will not easily tip over, thereby facilitating the subsequent connection between the first circuit board 12 and the connecting portion 1318.

It should be noted that the connecting portion 1318 and the two elastic portions 1317 may be integrally formed, such as integrally stamped and formed. This can simplify the processing of the first connector 131 and ensure good connection strength between the connecting portion 1318 and each of the two elastic portions 1317.

In the embodiment of the present application, a plurality of first connectors 131, a plurality of second connectors 221, and a plurality of conductive members 1311 are provided, and the first connectors 131, the second connectors 221, and the conductive members 1311 are arranged in one-to-one correspondence respectively.

Through such arrangement, electrical connection between different circuits of the first circuit board 12 and the second circuit board 21 can be achieved.

In the embodiment of the present application, the second connector 221 is a spring-loaded pin, and the central axis of the second connector 221 is parallel to the first circuit board 12. The elastic portion 1317 extends from the connecting portion 1318 toward the central axis of the second connector 221, and a part of the elastic portion 1317 is bent toward the side close to the conductive member 1311 to form an arc connecting section 1319, and the arc connecting section 1319 presses against the conductive member 1311.

Through such arrangement, the arc connecting section 1319 formed by bending can enable the elastic portion 1317 to more stably abuts the conductive member 1311, thereby ensuring the stability of the electrical connection between the first connector 131 and the conductive member 1311.

In a second aspect, the embodiments of the present application provide an aerosol generating device 100, which includes the electrical connection structure as described in the first aspect.

In the aerosol generating device 100 provided by the embodiment of the present application, since the first circuit board 12 is connected to the first connector 131, the first connector 131 includes a connecting portion 1318 and an elastic portion 1317, the second circuit board 21 is connected to the second connector 221, the electrical connection structure further includes the conductive member 1311, and the second connector 221 abuts against the conductive member 1311, an electrical connection between the first circuit board 12 and the second circuit board 21 can be achieved merely by abutting the elastic portion 1317 against one of the conductive member 1311 and the second circuit board 21, and electrically connecting the connecting portion 1318 to the other of the conductive member 1311 and the first circuit board 12. Specifically the first connector 131 abuts against the conductive member 1311, and the second connector 221 abuts against the conductive member 1311. This enables the first connector 131 and the second connector 221 to be electrically connected via the conductive member 1311 without direct connection therebetween. Thus, the first circuit board 12 and the second circuit board 21 can be arranged more flexibly, occupy less installation space in the aerosol generating device 100 respectively, and facilitate assembly.

It can be understood that the aerosol generating device 100 provided by the embodiment of the present application may further include an atomization unit 11, a liquid storage chamber 43, a second power battery 23, and the like. The atomization unit 11 and the second power battery 23 are electrically connected via the electrical connection structure.

In the embodiment of the present application, the aerosol generating device 100 includes an atomization module 10 and a power supply module 20. The atomization module 10 and the power supply module 20 are fixed together by magnetic attraction, such that the atomization module 10 and the power supply module 20 can be easily separated and connected.

The first circuit board 12 is a main circuit board disposed in the atomization module 10, the first connector 131 is an conductive spring plate soldered on the first circuit board 12, the second circuit board 21 is a sub circuit board disposed in the power supply module 20, the second connector 221 is a spring-loaded pin soldered on the second circuit board 21, both the bracket 15 and the conductive member 1311 are disposed on the atomization module 10, and the conductive member 1311 is fixed on the bracket 15 by injection molding.

When the power supply module 20 is magnetically attracted to the atomization module 10, the first circuit board 12 and the second circuit board 21 are arranged perpendicular to each other, forming a 90-degree angle. Thus, the first circuit board 12 and the second circuit board 21 each occupy a small space and are easy to assemble. The first connector 131 and the second connector 221 respectively abut opposite ends of the conductive member 1311, ensuring good and stable contact between the first connector 131, the second connector 221, and the conductive member 1311, thereby realizing the function of the power supply module 20 charging the atomization module 10.

The aerosol generating device 100 provided by the embodiment of the present application can solve the problems of small internal space and difficult assembly of the aerosol generating device 100 itself. Additionally, the first circuit board 12 and the second circuit board 21 do not need to be connected by cables, saving material costs and labor costs.

In the embodiment of the present application, the aerosol generating device 100 further includes a first housing 14 and a second housing 24. The first housing (14) defines a first receiving room (141), and the second housing (24) defines a second receiving room (242). The first circuit board 12 and the first connector 131 are respectively disposed in the first receiving room (141), the conductive member 1311 is disposed on or in the first housing 14, and at least part of the conductive member 1311 is exposed outside the first housing 14; the second circuit board 21 and the second connector 221 are disposed in the second receiving room (242), and part of the second connector 221 is exposed outside the second housing 24.

When the first housing 14 is connected to the second housing 24, the second connector 221 abuts the conductive member 1311, the first circuit board 12 and the second circuit board 21 are electrically connected, and the first circuit board 12 and the second circuit board 21 are perpendicular to each other.

In the embodiment of the present application, the bracket 15 is connected to the first housing 14, and the bracket 15 defines the receiving hole 152.

### Embodiment 2

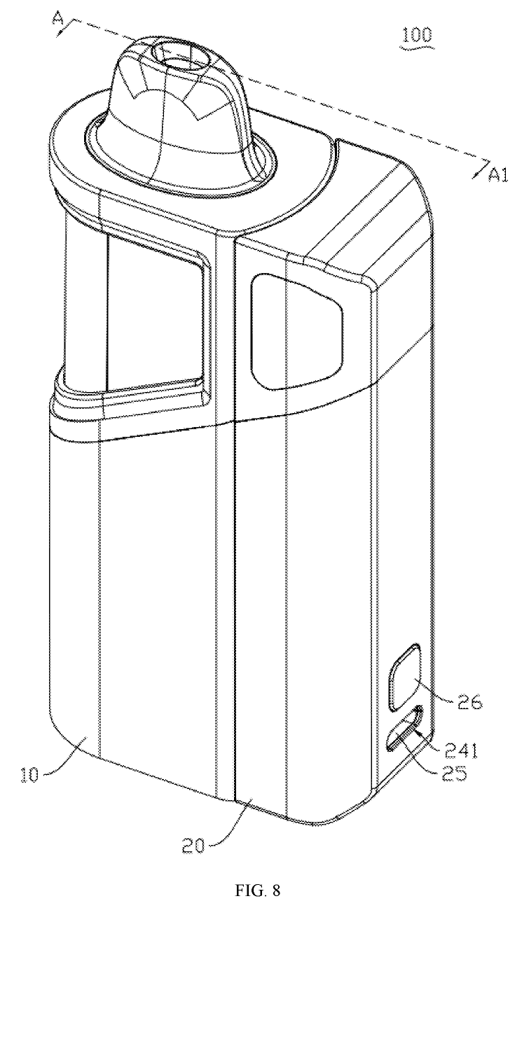

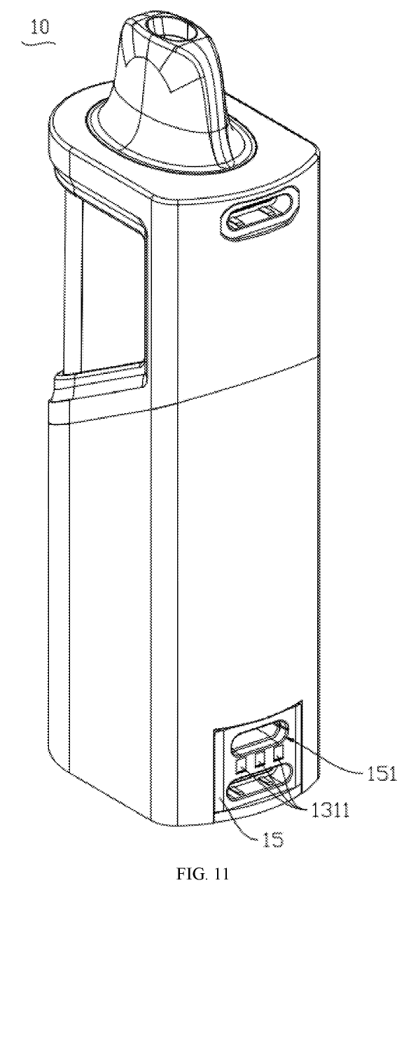

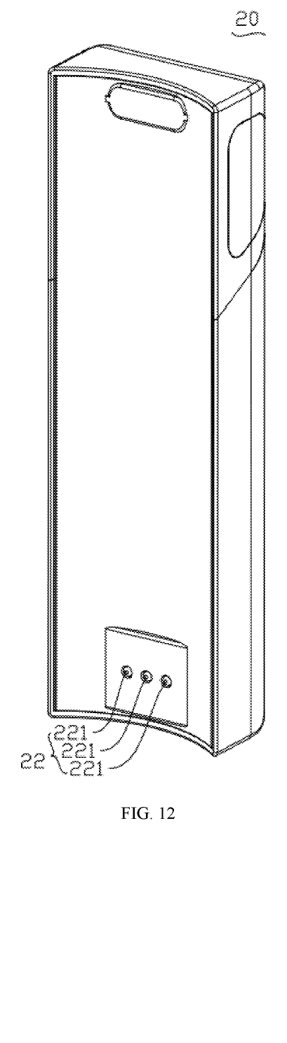

Please referring to FIGS. 8-12, the present application provides an electrical connection structure and an aerosol generating device 100. The aerosol generating device 100 includes an atomization module 10 and a power supply module 20. The electrical connection structure is part of the atomization module 10 and the power supply module 20. The power supply module 20 is connected to the atomization module 10 and configured to supply power to the atomization module 10.

The atomization module 10 includes an atomization unit 11, a first circuit board 12, and a first connection assembly 13. The first circuit board 12 is electrically connected to the atomization unit 11 and the first connection assembly 13 respectively.

The power supply module 20 is detachably connected to the atomization module 10. The power supply module 20 includes a second circuit board 21, a second connection assembly 22, and a second power battery 23. The second circuit board 21 is electrically connected to the second connection assembly 22 and the second power battery 23 respectively. The electrical connection structure includes the first connection assembly 13 and the second connection assembly 22.

The first connection assembly 13 includes a plurality of the first connectors 131, and the second connection assembly 22 includes a plurality of the second connectors 221. One of the first connection assembly 13 and the second connection assembly 22 further includes a plurality of the conductive members 1311. The first connectors 131, the second connectors 221, and the conductive members 1311 are consistent in quantity, and the first connectors 131, the second connectors 221, and the conductive members 1311 are arranged in one-to-one correspondence.

One of the first connector 131 and the second connector 221 is a spring-loaded pin, and the other thereof is a conductive spring sheet. When the power supply module 20 is connected to the atomization module 10, each spring-loaded pin is electrically connected to a corresponding conductive spring sheet via a corresponding conductive member 1311 respectively. This allows the second power battery 23 to supply power to the atomization module 10, enables the first circuit board 12 and the second circuit board 21 to be perpendicular to each other, and effectively shortens the distance between the first circuit board 12 and the second circuit board 21. Additionally, the first circuit board 12 electrically connected to the plurality of conductive spring sheet can be closely attached to the inner wall of the corresponding housing of the atomization module 10, thereby reducing the overall volume of the atomization module 10; alternatively, the second circuit board 21 electrically connected to the plurality of conductive spring sheet can be closely attached to the inner wall of the corresponding housing of the power supply module 20, thereby reducing the overall volume of the power supply module 20. By reducing the overall volume of the atomization module 10 or the power supply module 20, the miniaturization of the overall volume of the aerosol generating device 100 is achieved, which further reduces packaging costs, transportation space occupation, and transportation costs, and facilitates holding and carrying by users.

In the embodiment of the present application, the first connector 131 is a conductive spring sheet. The atomization module 10 includes a first housing 14 defining a first receiving room 141 and a bracket 15. The atomization unit 11, the first circuit board 12, and the plurality of conductive spring sheet are respectively disposed in the first receiving room 141. The bracket 15 is disposed in the first housing 14. Each conductive spring sheet is integrally formed on the bracket 15, such that the plurality of conductive spring sheet can be stably connected to the bracket 15, thereby simplifying the assembly steps of the atomization module 10 and improving the assembly efficiency thereof.

In addition, by fixedly connecting the bracket 15 to the first housing 14 and fixing the first circuit board 12 in the first housing 14, the plurality of conductive spring sheet can be stably electrically connected to the first circuit board 12. Moreover, when the atomization module 10 is connected to the power supply module 20, the plurality of conductive spring sheet can be stably electrically connected to one spring-loaded pin via one conductive member 1311 respectively. This enables the first circuit board 12 and the second circuit board 21 to be stably electrically connected via the conductive spring sheet, the conductive members 1311, and the spring-loaded pins, ensuring the stability of the electrical connection between the atomization module 10 and the power supply module 20.

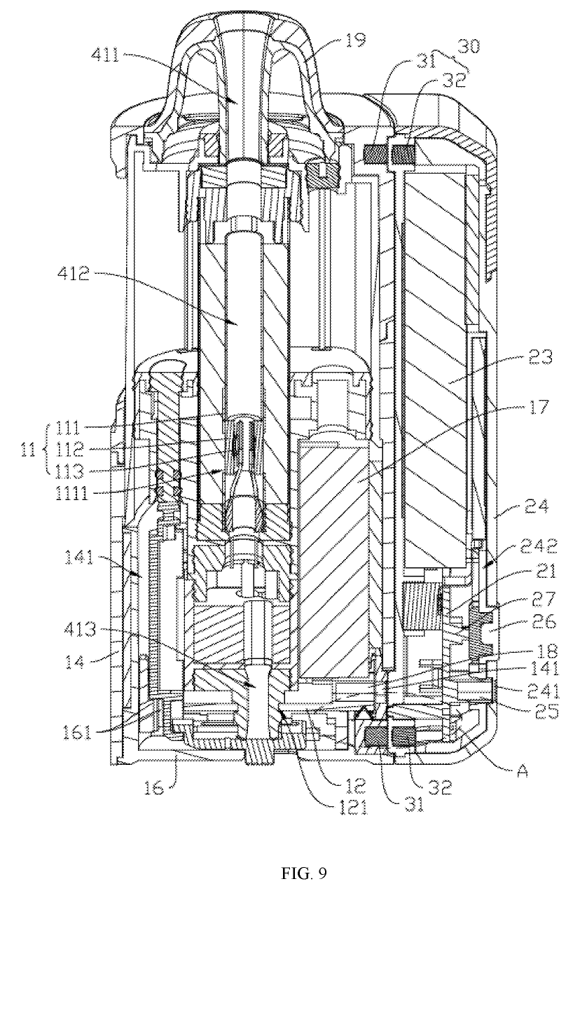

Please referring to FIG. 9, the atomization module 10 further includes a mounting member 16. The mounting member 16 is disposed in the first receiving room 141 and configured to mount the first circuit board 12. When the first circuit board 12 is disposed on the mounting member 16, the first circuit board 12 is electrically connected to the plurality of conductive spring sheet. This avoids pre-electrically connecting the conductive spring sheet to the first circuit board 12, thereby facilitating the assembly of the first circuit board 12 on the mounting member 16 and the installation of the integrally formed conductive spring sheet and bracket 15 in the first housing 14.

In addition, by directly connecting the conductive spring sheet to the first circuit board 12, it is also possible to avoid arranging electrical connection wires between the conductive spring sheet and the first circuit board 12. This reduces the assembly steps corresponding to connecting the electrical connection wires to the first circuit board 12 and the conductive spring sheet respectively, and avoids the risk of electrical connection failure between the first circuit board 12 and the second circuit board 21 caused by the failure of the electrical connection wires.

In the embodiment of the present application, the first circuit board 12 is arranged horizontally, the second circuit board 21 is arranged perpendicularly, the second connecting member 221 is a spring-loaded pin, and the second connecting member 221 is arranged horizontally.

In the embodiment of the present application, the connecting portion 1318 is embedded in the bracket 15, and the first circuit board 12 presses against the elastic portion 1317 to cause the elastic portion 1317 to be elastically deformed and be electrically connected to the first circuit board 12.

In the embodiment of the present application, the first connection assembly 13 includes a plurality of the conductive members 1311, and each of the conductive members 1311 and the corresponding first connector 131 form an integrated conductive spring sheet structure. Thus, each first connector 131 and the corresponding conductive member 1311 are integrally formed on the bracket 15, enabling each conductive member 1311 to stably electrically connect the corresponding first connector 131 and one second connector 221.

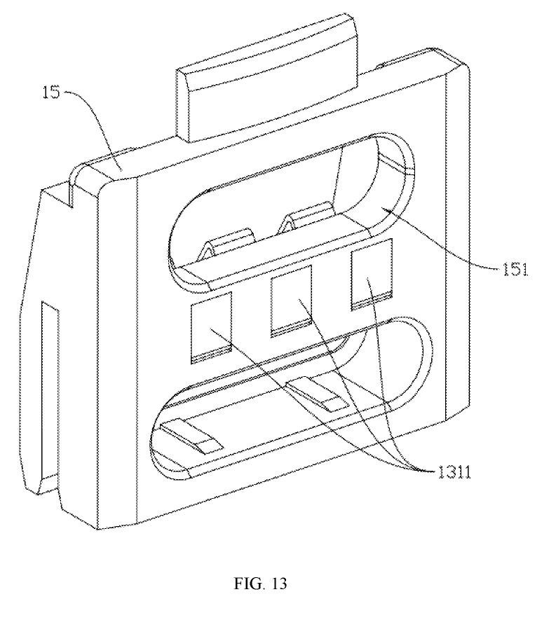

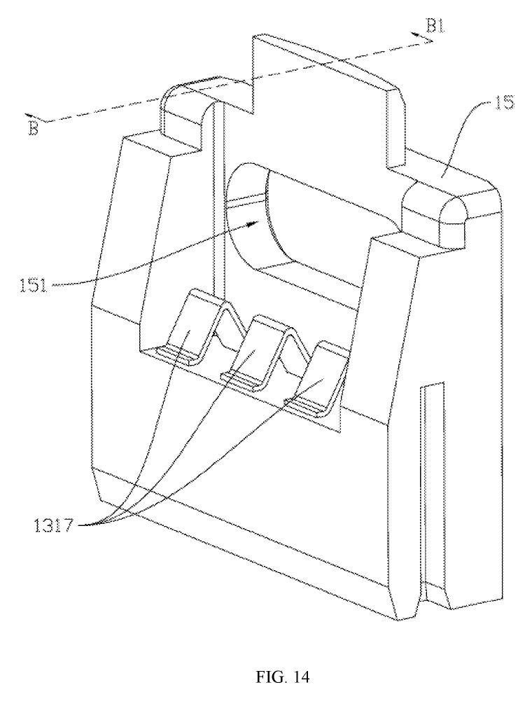

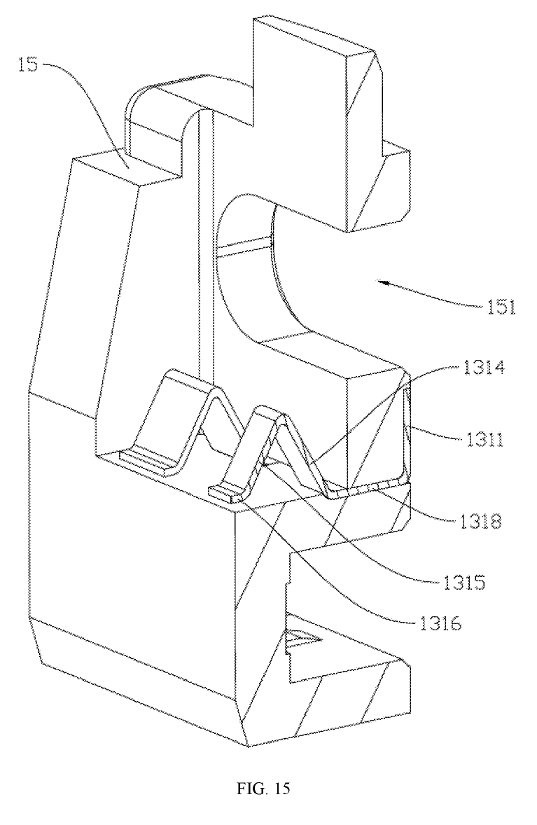

Please referring to FIGS. 13-16, the conductive spring sheet includes a connecting portion 1318 and an elastic portion 1317 connected in sequence. The conductive member 1311 is exposed on the outer surface of the atomization module 10 and adjacent to the power supply module 20, and the conductive member 1311 is configured to be electrically connected to the spring-loaded pin. The connecting portion 1318 is connected between the conductive member 1311 and the elastic portion 1317, and the conductive member 1311 are integrally formed on the bracket 15 via the connecting portion 1318, such that the conductive spring sheet penetrates and is fixed on the bracket 15. The elastic portion 1317 is disposed in the first housing 14. When the first circuit board 12 is disposed on the mounting member 16, the first circuit board 12 abuts against the elastic portion 1317, causing the elastic portion 1317 to be elastically deformed and electrically connected to the first circuit board 12.

In an embodiment of the present application, the conductive member 1311 is disposed on an outer surface of the bracket 15, and the conductive member 1311 is disposed between the second connector 221 and the bracket 15.

The elastic portion 1317 is elastically deformed under the abutment of the first circuit board 12, enabling stable electrical connection between the elastic portion 1317 and the first circuit board 12, thereby achieving stable electrical connection between the first circuit board 12 and the second circuit board 21.

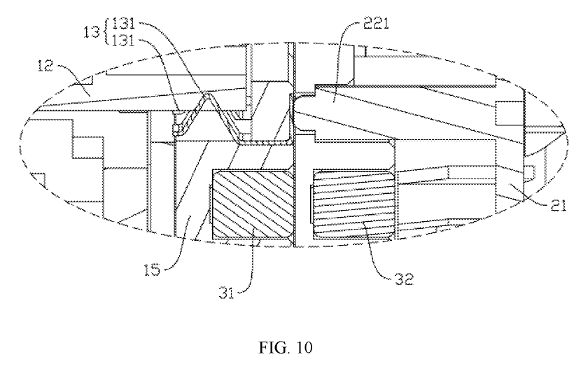

Please referring to FIGS. 9-10, the conductive member 1311 is perpendicular to the connecting portion 1318, and the conductive member 1311 is integrally embedded in the bracket 15. This allows a portion of the conductive member 1311 to be integrally connected to the bracket 15, thereby further increasing the connection area between the conductive spring sheet and the bracket 15, and further improving the connection strength and stability between the bracket 15 and the conductive spring sheet.

The elastic portion 1317 and the conductive member 1311 are respectively located on the same side of the connecting portion 1318, making the structure of each conductive spring sheet more compact, thereby further reducing the space occupation of the conductive spring sheet in the atomization module 10 and achieving miniaturization of the atomization module 10.

The elastic portion 1317 has a first state and a second state relative to the bracket 15. In the first state, the first circuit board 12 is not assembled on the mounting member 16, so the elastic portion 1317 is not in contact with the first circuit board 12, and at this time, the elastic portion 1317 is suspended on the bracket 15.

In the second state, the elastic portion 1317 is elastically deformed under the abutment of the first circuit board 12, enabling stable electrical connection between the elastic portion 1317 and the first circuit board 12. The elastic portion 1317 also abuts against the bracket 15, thereby further stabilizing the connection between the elastic portion 1317 and the first circuit board 12 and preventing the elastic portion 1317 from detaching from the first circuit board 12.

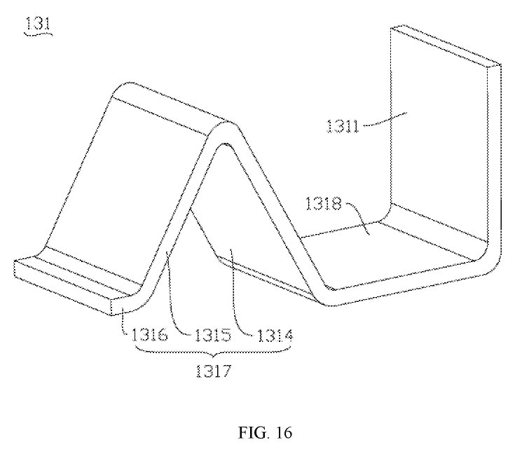

Please referring to FIGS. 15-16, the elastic portion 1317 includes a first arm 1314, a second arm 1315, and a third arm 1316. The first arm 1314 is connected to the connecting portion 1318 and extends obliquely in a direction toward the first circuit board 12 and away from the connecting portion 1318 (i.e., the first arm 1314 and the conductive member 1311 are respectively located on the same side of the connecting portion 1318). The second arm 1315 is connected to an end of the first arm 1314 remote from the connecting portion 1318, and the second arm 1315 extends obliquely from the end of the first arm 1314 remote from the connecting portion 1318 along a direction away from the first circuit board 12 and away from the connecting portion 1318. The third arm 1316 is connected to an end of the second arm 1315 remote from the first arm 1314 and extends horizontally away from the connecting portion 1318 (i.e., the first arm 1314 and the second arm 1315 are approximately connected in an inverted V-shape on the same side of the connecting portion 1318). The third arm 1316 is connected to the end of the second arm 1315 remote from the first arm 1314 and extends parallel to the connecting portion 1318 toward a direction away from the connecting portion 1318. Thus, when the elastic portion 1317 is elastically deformed under the abutment of the first circuit board 12, the angle between the first arm 1314 and the second arm 1315 relative to the bracket 15 increases, and the third arm 1316 abuts against the bracket 15.

The length of the first arm 1314 is greater than that of the second arm 1315, such that the third arm 1316 is also located on one side of the connecting portion 1318.

The mounting member 16 has a plurality of support ribs 161 and a plurality of limiting portions. When the first circuit board 12 is disposed on the mounting member 16, the plurality of support ribs 161 respectively support a first surface that is of the first circuit board 12 and is adjacent to the elastic portion 1317, and the plurality of limiting portions respectively limit a second surface that is of the first circuit board 12 and is away from the elastic portion 1317. The limiting portion may be an elastic clamping arm structure.

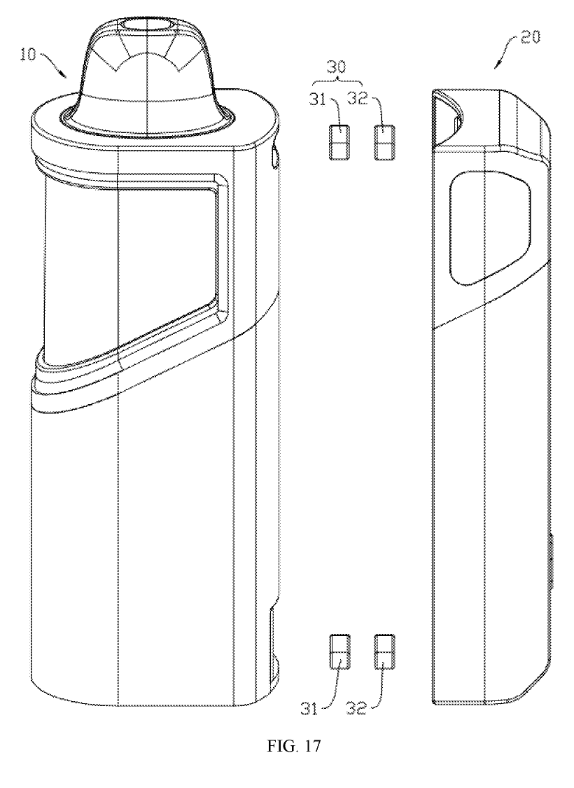

Please referring to FIGS. 9-10 and 17-19, the aerosol generating device 100 further includes a connection module 30. The connection module 30 is configured to connect the atomization module 10 and the power supply module 20 together, thereby enabling electrical connection between the first connection assembly 13 and the second connection assembly 22.

The connection module 30 includes a first magnetic member 31 and a second magnetic member 32. The first magnetic member 31 is disposed on the atomization module 10, and at least one first magnetic member 31 is adjacent to the first connection assembly 13. The second magnetic member 32 is disposed on the power supply module 20, and at least one second magnetic member 32 is adjacent to the second connection assembly 22 and magnetically attracted to the first magnetic member 31 adjacent to the first connection assembly 13. Under the magnetic attraction between the first magnetic member 31 and the second magnetic member 32, the first connection assembly 13 and the second connection assembly 22 can maintain stable electrical connection.

Please referring to FIGS. 9 and 18-19, the atomization module 10 further includes a first power battery 17 and a first charging interface 18. The first power battery 17 and the first charging interface 18 are respectively electrically connected to the first circuit board 12. The first power battery 17 is accommodated in the first receiving room 141 and configured to supply power to the atomization unit 11 and the first circuit board 12. The first housing 14 or the bracket 15 defines a first avoidance hole 151 corresponding to the first charging interface 18, enabling the first charging interface 18 to be electrically connected to a charging cable for charging the first power battery 17.

Please referring to FIGS. 9 and 18-19, the power supply module 20 further includes a second housing 24 defining a second receiving room 242 and a second charging interface 25. The second circuit board 21 and the second power battery 23 are respectively disposed in the second receiving room 242. The second charging interface 25 is electrically connected to the second circuit board 21. The second housing 24 defines a second avoidance hole 241 corresponding to the second charging interface 25, enabling the second charging interface 25 to be electrically connected to the charging cable for charging the second power battery 23.

By providing the first charging interface 18 and the second charging interface 25, the first power battery 17 and the second power battery 23 can be charged simultaneously via respective charging cables, thereby improving the charging speed of the first power battery 17 and the second power battery 23, and further enhancing the charging efficiency of the aerosol generating device 100.

By providing the first power battery 17, the atomization module 10 can be used independently of the power supply module 20, such that users can continue to use the atomization module 10 while the second power battery 23 of the power supply module 20 is being charged.

By providing the power supply module 20, the electric energy storage capacity of the aerosol generating device 100 can be effectively increased, thereby improving the standby time and the usage time of the aerosol generating device 100 after each full charge.

The first charging interface 18 faces the power supply module 20. When the power supply module 20 is connected to the atomization module 10, the power supply module 20 shields the first charging interface 18, thereby protecting the first charging interface 18 and reducing the risk of foreign objects entering the first charging interface 18.

Please referring to FIG. 9, the power supply module 20 further includes a control button 26 and a control switch 27. The control button 26 is disposed on the second circuit board 21, and the control switch 27 is disposed on the second housing 24. The control switch 27 is movable relative to the second housing 24 under external force to control the control button 26.

The atomization module 10 further includes a mouthpiece 19. The mouthpiece 19 is communicated with the air outlet end of the atomization unit 11, and the mouthpiece 19 is configured for users to inhale.

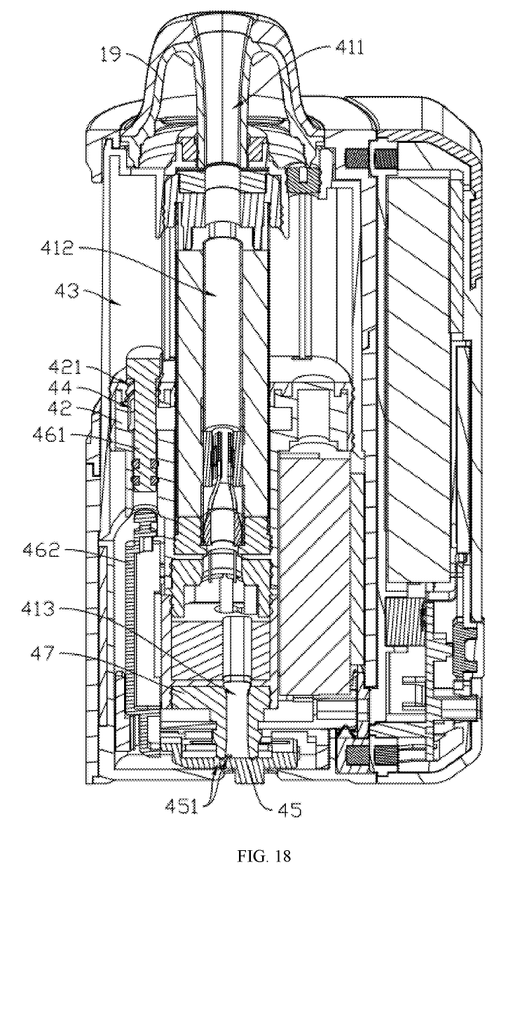

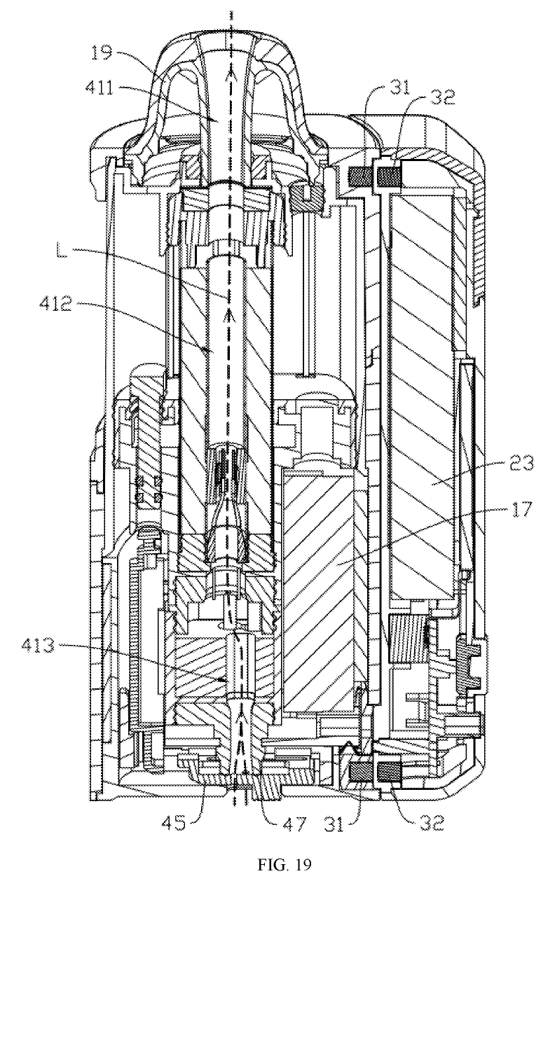

Please referring to FIGS. 18-19, the first housing 14 is configured to form an atomization air passage, and the air outlet end of the atomization air passage is communicated with the outside of the aerosol generating device 100. The atomization module 10 further includes a mounting base 42. The first housing 14 is hermetically connected to the mounting base 42 to define a liquid storage chamber 43 and a buffer chamber 44.

The atomization unit 11 includes an atomization tube 111, a liquid-conducting cotton 112, and a heating element 113. The atomization air passage includes a mouthpiece section 411 and an atomization section 412 which are communicated with each other. An end of the mouthpiece section 411 remote from the atomization section 412 is the air outlet end. The atomization tube 111 forms the atomization section 412, and the atomization unit 11 is disposed in the atomization section 412. The liquid-conducting cotton 112 is disposed on the inner wall of the atomization tube 111 and covers the liquid-conducting hole 1111 of the atomization tube 111 communicating with the liquid storage chamber 43. The heating element 113 is disposed on the inner wall of the liquid-conducting cotton 112. The aerosol substrate in the liquid storage chamber 43 moves to the liquid-conducting cotton 112 through the liquid-conducting hole 1111, and is heated and atomized to generate aerosol which is released into the atomization section 412 when the heating element 113 is energized.

Please referring to FIGS. 18-19, the atomization module 10 further includes a sealing member 47. The atomization air passage further includes an air inlet section 413, and the sealing member 47 is configured to form the air inlet section 413. The air inlet section 413 is communicated with an end of the atomization section 412 remote from the mouthpiece section 411, such that the atomization section 412 is communicated between the air inlet section 413 and the mouthpiece section 411. The air inlet section 413 is configured to form an air inlet end, and external air flows into the atomization air passage from the air inlet end.

The atomization module 10 further includes an adjusting member 45. The adjusting member 45 is disposed on the first housing 14 and has a first position and a second position relative to the first housing 14. The first circuit board 12 is provided with a limiting hole 121, and the sealing member 47 passes through the limiting hole 121 and abuts against the adjusting member 45.

Please referring to FIGS. 9 and 18-19, when the adjusting member 45 is in the first position, the adjusting member 45 blocks the air inlet end; when the adjusting member 45 is in the second position, the adjusting member 45 opens the air inlet end.

The adjusting member 45 defines a plurality of air inlet holes 451, and the adjusting member 45 further has a third position, which is different from the first position and the second position. When the adjusting member 45 is in the second position, part of the air inlet holes 451 communicate the air inlet section 413 with the outside; when the adjusting member 45 is in the third position, all the air inlet holes 451 communicate the air inlet end with the outside simultaneously.

The buffer chamber 44 is communicated with the liquid-conducting hole 1111. The mounting base 42 defines a liquid passing hole 421, and the liquid passing hole 421 is communicated between the liquid storage chamber 43 and the buffer chamber 44. Thus, the aerosol substrate in the liquid storage chamber 43 sequentially flows through the liquid passing hole 421, the buffer chamber 44, and the liquid-conducting hole 1111 and arrive the liquid-conducting cotton 112.

The atomization module 10 further includes a control assembly. The control assembly is detachably disposed at the liquid passing hole 421 and has a blocking position and a conducting position. When the control assembly is in the blocking position, the liquid passing hole 421 is blocked, such that the liquid storage chamber 43 is isolated from the buffer chamber 44, and the aerosol substrate in the liquid storage chamber 43 cannot move to the buffer chamber 44. When the control assembly is in the conducting position, the liquid passing hole 421 is communicated between the liquid storage chamber 43 and the buffer chamber 44, and the aerosol substrate in the liquid storage chamber 43 can move to the buffer chamber 44 through the liquid passing hole 421.

Please referring to FIGS. 9 and 18-19, the control assembly includes a blocking member 461, a pushing member 462, and an elastic connecting member. The blocking member 461 is connected to the pushing member 462. The elastic connecting member is configured to drive the pushing member 462 to drive the blocking member 461 to move synchronously, so as to maintain the control assembly in the conducting position.

When the adjusting member 45 is in the first position, external air cannot enter the atomization air passage through the air inlet end. Meanwhile, the adjusting member 45 also abuts against the pushing member 462, causing the pushing member 462 to overcome the force of the elastic connecting member and drive the blocking member 461 to block the liquid passing hole 421, such that the aerosol substrate in the liquid storage chamber 43 cannot move to the buffer chamber 44.

When the adjusting member 45 is in the second position or the third position, external air can enter the atomization air passage from the air inlet end through the air inlet holes 451. Meanwhile, the air adjusting plate portion releases the pushing member 462, such that the pushing member 462 opens the liquid passing hole 421 under the driving of the elastic connecting member, thereby enabling the aerosol substrate in the liquid storage chamber 43 to move to the buffer chamber 44.

In the embodiment of the present application, the aerosol generating device 100 includes: an atomization module 10, which includes a first housing 14, the first circuit board 12, the first connector 131, and the conductive member 1311; the first circuit board 12 and the first connector 131 are respectively disposed in the first receiving room 141; the conductive member 1311 is disposed on or in the first housing 14, and at least part of the conductive member 1311 is exposed outside the first housing 14; the conductive member 1311 is electrically connected to the first connector 131; and a power supply module 20, which includes a second housing 24, the second circuit board 21, and the second connector 221; the second circuit board 21 and the second connector 221 are disposed in the second receiving room 242; part of the second connector 221 is exposed outside the second housing 24;when the atomization module 10 is connected to the power supply module 20, the second connector 221 abuts against the conductive member 1311, the first circuit board 12 and the second circuit board 21 are electrically connected, and the first circuit board 12 and the second circuit board 21 are perpendicular to each other.

It should be noted that the electronic atomization device 100 provided in the embodiment of the present application may further includes a housing 10, a circuit board, a power supply, a sealing member, and the like, which are not repeated herein.

For ease of description, spatially relative terms such as "on top of," "above," "on the upper surface of," and "upper" may be used herein to describe the spatial positional relationship between one device or feature and other devices or features as shown in the drawings. It should be understood that spatially relative terms are intended to encompass orientations of the device in use or operation other than the orientation depicted in the drawings. For example, if the device in the drawings is inverted, a device described as "above another device or structure" or "on top of another device or structure" will then be positioned as "below the other device or structure" or "under the other device or structure." Thus, the exemplary term "above" can encompass both an orientation of "above" and "below." The device may also be oriented in other ways (rotated 90 degrees or at other orientations), and the spatially relative descriptors used herein should be interpreted accordingly.

Additionally, it should be noted that the use of terms such as "first" and "second" to define components is merely for the convenience of distinguishing the corresponding components. Unless otherwise specified, the aforementioned terms have no special meaning and thus shall not be construed as limiting the scope of protection of the present application.

The above are merely preferred embodiments of the present application and are not intended to limit the present application. For those skilled in the art, various modifications and variations may be made to the present application. Any modification, equivalent replacement, or improvement made within the spirit and principle of the present application shall be included in the scope of protection of the present application.

1. An electrical connection structure for an aerosol generating device (100), comprising:
a first circuit board (12) being mechanically and electrically connected to a first connector (131);
a second circuit board (21) being mechanically and electrically connected to a second connector (221); and
a conductive member (1311), wherein the second connector (221) abuts against and is electrically connected to the conductive member (1311);
wherein the first connector (131) comprises a connecting portion (1318) and an elastic portion (1317), the elastic portion (1317) is connected to the connecting portion (1318), the elastic portion (1317) abuts one of the conductive member (1311) and the first circuit board (12), the connecting portion (1318) is mechanically and electrically connected to another one of the conductive member (1311) and the first circuit board (12).

2. The electrical connection structure of claim 1, wherein the elastic portion (1317) and the second connector (221) respectively abut two opposite ends of the conductive member (1311).

3. The electrical connection structure of claim 2, further comprising a bracket (15), wherein a receiving hole (152) is defined in the bracket (15), the conductive member (1311) is disposed in the receiving hole (152), the bracket (15) forms a limiting surface (1523) in the receiving hole (152), and the elastic portion (1317) presses against the conductive member (1311) such that the conductive member (1311) abuts against the limiting surface (1523).

4. The electrical connection structure of claim 3, wherein the receiving hole (152) comprises a first hole (1521) and a second hole (1522) in communicating with the first hole (1521), the limiting surface (1523) is formed at a junction between the first hole (1521) and the second hole (1522); the conductive member (1311) comprises a first portion (13111) and a second portion (13112) connected to the first portion (13111) , the first portion (13111) is located in the first hole (1521), the second portion (13112) is located in the second hole (1522), the elastic portion (1317) abuts against an end of the first portion (13111) away from the second portion (13112), the second connector (221) abuts against an end of the second portion (13112) away from the first portion (13111).

5. The electrical connection structure of claim 1, wherein the first circuit board (12) and the second circuit board (21) are arranged perpendicularly, the second connector (221) and the second circuit board (21) are arranged perpendicularly.

6. The electrical connection structure of claim 1, wherein the first circuit board (12) is arranged horizontally, the connecting portion (1318) is disposed on an outer surface of the first circuit board (12), and the connecting portion (1318) is mechanically and electrically connected to the first circuit board (12).

7. The electrical connection structure of claim 6, wherein the second connecting member (221) is a spring-loaded pin, a central axis of the second connector (221) is parallel to the first circuit board (12), the elastic portion (1317) extends from the connecting portion (1318) toward the central axis of the second connector (221), and a part of the elastic portion (1317) is bent toward the conductive member (1311) to form an arc connecting section (1319), and the arc connecting section (1319) presses against the conductive member (1311).

8. The electrical connection structure of claim 1, wherein the electrical connection structure comprises a first connection assembly (13) and a second connection assembly (22), the first connection assembly (13) comprises a plurality of the first connectors (131), the second connection assembly (22) comprises a plurality of the second connectors (221), one of the first connection assemblies (13) and the second connection assemblies (22) further comprises a plurality of the conductive members (1311), the first connectors (131), the second connectors (221), and the conductive members (1311) are consistent in quantity, and the first connectors (131), the second connectors (221), and the conductive members (1311) are arranged in a one-to-one correspondence manner.

9. The electrical connection structure of claim 1, wherein the conductive member (1311) and the first connector (131) are of an integral sheet structure, the connecting portion (1318) is connected between the elastic portion (1317) and the conductive member (1311), the elastic portion (1317) abuts against the first circuit board (21).

10. The electrical connection structure of claim 9, further comprising a bracket (15), the conductive member (1311) is disposed on an outer surface of the bracket (15), and the conductive member (1311) is located between the second connecting member (221) and the bracket (15).

11. The electrical connection structure of claim 10, further comprising a mounting member (16), wherein the first circuit board (12) is arranged horizontally and disposed on the mounting member (16), the second circuit board (21) is arranged perpendicularly, the second connecting member (221) is a spring-loaded pin, and the second connecting member (221) is arranged horizontally.

12. The electrical connection structure of claim 11, wherein the connecting portion (1318) is embedded in the bracket (15), and the first circuit board (12) presses against the elastic portion (1317) to cause the elastic portion (1317) to be elastically deformed and be electrically connected to the first circuit board (12).

13. The electrical connection structure of claim 12, wherein the connecting portion (1318) is perpendicular to the conductive member (1311), and the conductive member (1311) is integrally formed and embedded in the bracket (15).

14. The electrical connection structure of claim 13, wherein the elastic portion (1317) and the conductive member (1311) are respectively located on a same side of the connecting portion (1318);
the elastic portion (1317) comprises a first state and a second state; in the first state, the elastic portion (1317) is not in contact with the first circuit board (12) and is suspended above the bracket (15); in the second state, the first circuit board (12) presses against the elastic portion (1317), and the elastic portion (1317) is elastically deformed and abuts against the bracket (15).

15. The electrical connection structure of claim 14, wherein the elastic portion (1317) comprises a first arm (1314), a second arm (1315), and a third arm (1316), the first arm (1314) is connected to the connecting portion (1318) and extends obliquely in a direction toward the first circuit board (12) and away from the connecting portion (1318), the second arm (1315) extends obliquely from an end of the first arm (1314) away from the connecting portion (1318) in a direction away from the first circuit board (12) and away from the connecting portion (1318), and the third arm (1316) extends horizontally from an end of the second arm (1315) away from the first arm (1314) in a direction away from the connecting portion (1318).

16. The electrical connection structure of claim 12, wherein the mounting member (16) comprises a plurality of support ribs (161) and a plurality of limiting portions, the plurality of support ribs (161) respectively support a first surface that is of the first circuit board (12) and is adjacent to the elastic portion (1317), and the plurality of limiting portions respectively limit a second surface that is of the first circuit board (12) and is away from the elastic portion (1317).

17. An aerosol generating device (100), comprising the electrical connection structure according to claim 1.

18. The aerosol generating device of claim 17, wherein the aerosol generating device further comprises an atomization module (10); the atomization module (10) comprises a first housing (14), the first circuit board (12), the first connector (131) and the conductive member (1311); the first housing (14) defines a first receiving room (141), the first circuit board (12) and the first connector (131) are respectively disposed in the first receiving room (141), the conductive member (1311) is disposed on the first housing (14) or in the first housing (14), the conductive member (1311) is partially exposed outside of the first housing (14), and the conductive member (1311) is electrically connected to the first connector (131); and
a power supply module (20) comprising a second housing (24), the second circuit board (21), and the second connector (221); the second housing (24) defines a second receiving room (242), the second circuit board (21) and the second connector (221) is disposed in the second receiving room (242), the second connector (221) is partially exposed outside of the second housing (24);
wherein when the atomization module (10) is connected to the power supply module (20), the second connector (221) abuts against and is electrically connected to the conductive member (1311).

19. An aerosol generating device (100), comprising:
a first housing (14), a first circuit board (12), a first connector (131) and a conductive member (1311); wherein the first housing (14) defines a first receiving room (141), the first circuit board (12) and the first connector (131) are respectively disposed in the first receiving room (141), the first circuit board (12) is horizontally arranged, the first connector (131) comprises a connecting portion (1318) and an elastic portion (1317), the connecting portion (1318) is disposed on the first circuit board (12) and electrically connected to the first circuit board (12), the elastic portion (1317) is connected to the connecting portion (1318), the conductive member (1311) is disposed on the first housing (14) or in the first housing (14), the conductive member (1311) is partially exposed outside of the first housing (14), and the conductive member (1311) abuts the elastic portion (1317); and
a second housing (24), a second circuit board (21), and a second connector (221); wherein the second housing (24) defines a second receiving room (242), the second circuit board (21) and the second connector (221) are disposed in the second receiving room (242), the second circuit board (21) is perpendicularly arranged, the second connecting member (221) is a spring-loaded pin and horizontally arranged, the second connector (221) is electrically connected to the second circuit board (21), and the second connector (221) is partially exposed outside of the second housing (24);
wherein when the first housing (14) is connected to the second housing (24), the elastic portion (1317) and the second connector (221) respectively abut two opposite ends of the conductive member (1311).

20. An aerosol generating device (100), comprising:
a first housing (14), a first circuit board (12), a first connector (131) and a conductive member (1311); wherein the first housing (14) defines a first receiving room (141), the first circuit board (12) and the first connector (131) are respectively disposed in the first receiving room (141), the first circuit board (12) is horizontally arranged, the conductive member (1311) and the first connector (131) are of an integral sheet structure, the first connector (131) comprises a connecting portion (1318) and an elastic portion (1317), the connecting portion (1318) is connected between the conductive member (1311) and the elastic portion (1317), the conductive member (1311) is disposed on the first housing (14) or in the first housing (14), the conductive member (1311) is partially exposed outside of the first housing (14), and the elastic portion (1317) abuts against the first circuit board (12) and is electrically connected to the first circuit board (12); and
a second housing (24), a second circuit board (21), and a second connector (221); wherein the second housing (24) defines a second receiving room (242), the second circuit board (21) and the second connector (221) are disposed in the second receiving room (242), second circuit board (21) is perpendicularly arranged, the second connector (221) is spring-loaded pin and horizontally arranged, the second connector (221) is electrically connected to the second circuit board (21), and the second connector (221) is partially exposed outside of the second housing (24);
wherein when the first housing (14) is connected to the second housing (24), the second connector (221) abuts against and is electrically connected to the conductive member (1311).
